(19) United States
(12) Patent Application Publication
(10) Pub. No.: US 2013/0332030 A1
(43) Pub. Date: Dec. 12, 2013

(54) INTELLIGENT VEHICLE SENSOR DEVICE

(71) Applicants: Vladimir Koukes, Darmstadt (DE); Ralf Herbst, Nastatten (DE); Rainer Kitz, Nidderau (DE); Robert Schmidt, Kelkheim (DE); Peter Wanke, Frankfurt (DE)

(72) Inventors: Vladimir Koukes, Darmstadt (DE); Ralf Herbst, Nastatten (DE); Rainer Kitz, Nidderau (DE); Robert Schmidt, Kelkheim (DE); Peter Wanke, Frankfurt (DE)

(73) Assignee: Continental Teves AG & CO. OHG, Frankfurt (DE)

(21) Appl. No.: 14/001,521

(22) PCT Filed: Mar. 1, 2012
(86) PCT No.: PCT/EP12/53508

§ 371 Date: Aug. 26, 2013

(30) Foreign Application Priority Data
Mar. 2, 2011 (DE) 10 2011 004 973.8

(51) Int. Cl. B60W 10/184; B60R 21/16; B60W 10/20

(52) U.S. Cl. CPC B60W 10/184; B60W 10/20; B60R 21/16
USPC 701/41; 701/36; 701/45; 701/71

(57) ABSTRACT

A vehicle sensor device, which includes at least one sensor for detecting the yaw rate of a vehicle, at least one sensor for detecting the lateral acceleration of a vehicle, at least one computing unit and at least one interface of a data bus, especially CAN or FlexRay, via which the sensor signals or sensor data derived therefrom can be transmitted to at least one electronic control device. According to an aspect of the invention, a steering angle sensor is integrated with the other sensors in a housing, and the computing unit carries out plausibility checking and/or calibration of the yaw rate signals and/or the lateral acceleration signals and/or the steering angle signals.

### CROSS REFERENCE TO RELATED APPLICATIONS

This application is the U.S. National Phase Application of PCT/EP2012/0535508, filed Mar. 1, 2012, which claims priority to German Patent Application No. 10 2011 004 973.8, filed Mar. 2, 2011, the contents of such applications being incorporated by reference herein.

### FIELD OF THE INVENTION

The invention relates to a vehicle sensor device, comprising at least one sensor for detecting the yaw rate of a vehicle, at least one sensor for detecting the lateral acceleration of a vehicle, at least one computing unit and at least one interface of a data bus, especially CAN or FlexRay, via which the sensor signals or sensor data derived therefrom can be transmitted to at least one electronic control device, and to its use in a brake system.

### BACKGROUND OF THE INVENTION

Motor vehicles today are equipped with a plurality of electronically regulated systems, wherein e.g. an electronic or electronically regulated brake system, an electrical steering system or electronic steering and any number of driver assistance systems (such as “Active Front Steering”, “Intelligent Headlamp Control” or others) can be active at the same time and use information from different sensors installed in the vehicle.

Particular information about the steering angle, the yaw rate, and/or lateral and longitudinal acceleration of the vehicle are very important, because these can be used for vehicle dynamics control, which holds the vehicle on the course desired by the driver by targeted driver-independent brake application, but other systems can also be used. Here there are mutually opposite requirements, to measure said values with high accuracy on the one hand and on the other hand to use very inexpensive sensors and evaluation circuits. The placement of a yaw rate sensor and a lateral acceleration sensor in a common housing at suitable points in the vehicle is known (this is often referred to as a “sensor cluster”). From WO2008/003346 A1, which is incorporated by reference, a sensor cluster is known, with which the yaw rate sensor and the lateral acceleration sensor (or corresponding sensors for all 3 spatial axes) and a computing unit are integrated in a housing. In DE 101 07 949 B4, which is incorporated by reference, it is proposed to combine the sensor cluster with the airbag control device. EP 1 313 635 B1, which is incorporated by reference, discloses the integration of the sensor cluster in an electronic-hydraulic control device of a brake system.

The steering angle sensor is installed separately in many vehicles. The most common are absolute steering angle sensors, which can detect the steering wheel position without displacement or offset. For signal processing an external control device is often used, as for example the control device of an electronic brake system. Said solution is associated with high costs for the sensors used and other components or the housing (hardware costs). If relative steering angle sensors are used, then a determination of the null position, i.e. a calibration of the steering angle signals has to take place. This is e.g. known from DE 10 2006 046 834 A1, which is incorporated by reference.

### SUMMARY OF THE INVENTION

An aspect of the present invention provides a plurality of sensor data required for the electronically regulated systems of a motor vehicle in an inexpensive manner with simultaneous high reliability.

A vehicle sensor device according to an aspect of the invention comprises at least one sensor for detecting the yaw rate of a vehicle, at least one sensor for detecting the lateral acceleration of a vehicle, at least one computing unit and at least one interface of a data bus, especially CAN or FlexRay, via which the sensor signals or sensor data derived therefrom can be transmitted to at least one electronic control device, wherein a steering angle sensor is only connected to the vehicle sensor device, is especially integrated with the other sensors in a housing, and the computing unit carries out plausibility checking and/or calibration of the yaw rate signals and/or the lateral acceleration signals and/or the steering angle signals.

Sensor signals are to be understood to mean the “raw information”, whereas sensor data contains both processed sensor signals and also information derived therefrom. Because the steering angle sensor is exclusively connected to the vehicle sensor device, the connection between the two can be specially adapted, e.g. with a particularly small number of wires or a particularly high strength noise immunity. The sensor data can be provided to a plurality of systems or control devices by means of the interface to a data bus. Here the sensor data can be sent in data packets with a suitable format, in order to transmit optimum information with the minimum possible load on the data bus.

Because the vehicle sensor device according to an aspect of the invention carries out the plausibility checking and/or calibration of the sensor signals, the load on the control device of the electronic brake system is advantageously reduced. Furthermore, the complexity of the control device software is reduced, which is advantageous in respect of verification of the accuracy and maintenance of the software. The vehicle sensor device according to the invention is especially advantageous for inexpensive vehicles, because a simplified control device is associated with lower production costs.

Advantageously, vehicle speed data are received via at least one interface and the yaw rate signals and lateral acceleration signals are plausibility checked using said data. In particular it is considered whether the product of yaw rate and vehicle speed deviates in magnitude from the measured lateral acceleration by no more than a specified threshold value. The reliability of the sensor data provided is thus increased and the receiving control devices can completely dispense with plausibility checking or the scope of the checks can be reduced.

It is particularly advantageous here if the vehicle speed data includes a vehicle speed derived from wheel revolution rate sensors and/or wheel speeds of a plurality of wheels and/or a wheel speed derived from navigation data. If there is a clear view to the sky, e.g. navigation devices can provide reliable vehicle speed data according to the GPS method or similar methods. Wheel revolution rate sensors are e.g. necessary to carry out brake slip control and are therefore available in almost all vehicles. A yaw rate of the vehicle may also be estimated from wheel speed differences.

Preferably, a calibration of relative steering angle signals is carried out at least using the data or signals of the yaw rate sensor and/or the lateral acceleration sensor, and absolute steering angle data are provided via at least one data bus interface. Said data are available to all connected control devices without further conversion effort.

It is advantageous if the computing unit is implemented as a redundant core microcontroller and preferably at least one sensor, especially a yaw rate sensor, lateral acceleration sensor and steering angle sensor, is/are implemented in redundant form. High operating reliability of the vehicle sensor device can be achieved in this way.

The vehicle sensor device preferably comprises at least one longitudinal acceleration sensor. The data of a longitudinal acceleration sensor are used for assistance functions such as a hill-start aid. Additionally, they can be used for estimating the vehicle speed (by integration) or for plausibility checking of received wheel sensor data.

It is particularly advantageous if the vehicle sensor device comprises a module for controlling airbags, wherein the data of one or a plurality of acceleration and/or structural sound sensors are evaluated by the computing unit. Provided sensor data may be evaluated to trigger the airbag. If additional acceleration sensors are used with a usable measurement range, which exceeds the accelerations normally occurring during a journey, they can be used for plausibility checking of the signals of the remaining sensors in order to detect short-term faults. Besides reduced costs the reduced volume required is also advantageous.

According to a preferred embodiment of the invention the computing unit controls a servomotor for assisting the steering movement by the driver, and this especially applies an additional steering torque according to data received via at least one interface. Advanced driving dynamics controls can thus be used, which reduce e.g.,the stopping distance on a highway with laterally different coefficients of friction (μ-split situation) by a combined braking and steering intervention, without additional control devices being necessary. In particular, it is also possible that the distribution of the functions between the control device of the brake system and the vehicle sensor device is carried out depending on the self-tests performed during initialization. The operational reliability of the overall system can thus be increased.

Advantageously, the vehicle sensor device comprises a power supply device, which is connected to a vehicle electrical system and provides at least one stabilized voltage and preferably comprises a capacitor that can bridge a failure of the vehicle electrical system for at least a specified period of time. This has the advantage that the sensor data are available independently of external circuits once the ignition has been activated, and preferably also for a specified additional period of time.

It is advantageous if the computing unit of the vehicle sensor device carries out a check for driver fatigue, wherein a warning is output via at least one interface if the steering wheel angle and/or the steering wheel angular rate is/are less than a first specified threshold value for a first specified period of time and subsequently exceed(s) a second specified threshold value before the expiry of a second specified period of time. A driver's “microsleep” can thus be detected and the need for a break indicated in good time.

Advantageously, the computing unit of the vehicle sensor device provides functions for one or more control devices according to a request from an electronic control device and/or according to a check of the provided sensors, wherein the transmission of data is carried out via at least one interface. The load on the corresponding control devices is thus reduced. Because the provided functions are selected depending on an external request and/or on the sensors provided, the vehicle sensor device can be used in a plurality of different vehicles with unchanged control software.

The invention further relates to the use of a vehicle sensor device according to the invention in a brake system for a motor vehicle driven by an internal combustion engine and/or at least one electric motor, wherein the brake system comprises means for driver-independent build-up of brake torque at one or more wheels and at least one electronic control device, which receives signals from at least one wheel revolution rate sensor and controls the means for driver-independent build-up of brake torque. Here the vehicle sensor device and the electronic control device are connected to each other by means of at least one data bus.

Preferably, the computing unit of the vehicle sensor device carries out vehicle dynamics control and sends brake demands via at least one data bus interface to the brake system control device(s). The complexity of the electronic control device of the brake system is thus reduced, enabling the use of a slower processor and/or ensuring simplification of the software structure.

In a preferred embodiment of the invention the vehicle sensor device according to the invention is used in connection with electromechanical brakes, i.e. especially the wheel brakes of at least one axle are operated electromechanically. According to a particularly preferred embodiment of the invention, vehicle dynamics control is carried out by the processor of the vehicle sensor device. There is thus no need for a standalone separate powerful brake system control device, rather the vehicle sensor device provides this functionality in combination with the control devices of the electromechanical wheel brakes.

According to a preferred embodiment of the invention, the brake system at the wheels of at least one axle is equipped with hydraulic wheel brakes and the electronic control device of the brake system comprises a hydraulic block with at least one pump and at least one hydraulic valve, wherein the electronic control device can control the hydraulic block for driver-independent changing of the brake pressure. In a particularly preferred embodiment of the invention the wheels of another axle are equipped with electromechanical wheel brakes.

### BRIEF DESCRIPTION OF THE DRAWINGS

Other preferred embodiments arise from the dependent claims and the following description of an exemplary embodiment using figures.

In the figures

FIG. 1 shows a first exemplary embodiment of the vehicle sensor device according to the invention,

FIG. 2 shows another exemplary embodiment,

FIG. 3 shows an alternative representation of the vehicle sensor device according to the invention, and

FIG. 4 shows a schematic of the software architecture of a vehicle sensor device according to the invention.

### DETAILED DESCRIPTION OF THE INVENTION

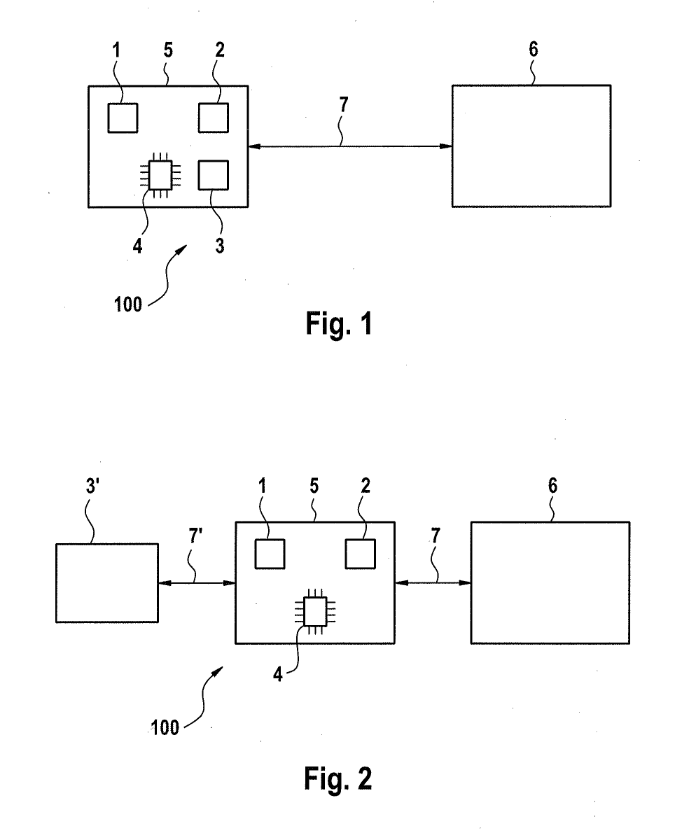

FIG. 1 shows an exemplary architecture of the vehicle sensor device according to the invention, i.e. of an intelligent sensor cluster 100. Here a yaw rate sensor 1, lateral acceleration sensor 2, steering angle sensor 3 (preferably relative) and a processor 4 are integrated on a common mother board 5. The sensor data are transmitted via a data bus 7 to the electronic control device 6 of the brake system. The data bus 7 can be implemented according to a standard such as CAN or FlexRay or a special or proprietary signaling schema and communications protocol can be used. Whilst bidirectional communication is provided between the vehicle sensor device 100 and the electronic control device 6 in the exemplary embodiment shown, in principle a purely unidirectional transfer of the sensor data to the control device 6 could also take place. Because the sensors are installed in a device, i.e. an intelligent sensor cluster or a vehicle sensor device according to the invention, the production costs are reduced. One advantage of the intelligent sensor cluster is that all sensor elements have a common power supply, built-in circuit board, connecting parts and housing and also use common software. The intelligent sensor cluster is advantageously installed on or in the steering column of the vehicle, because the steering angle sensor for detecting the steering angle is connected to the steering column.

In another embodiment the intelligent sensor cluster can also be integrated with the control device of an electrical steering system in a housing. Said alternative architecture of the vehicle sensor device according to the invention is illustrated in FIG. 2. In contrast to FIG. 1, here the computing unit controls an electronic steering system 3′, which provides steering angle information, enabling the steering angle sensor 3 to be omitted as a separate component. The transfer of the steering angle data and the request for a steering torque by the computing unit can take place both via a standard-conformant data bus 7′ and also via a special data connection. Advantageously, in said alternative architecture the power supply of the actuator is also provided by the vehicle sensor device, which especially also comprises a control circuit for the actuator.

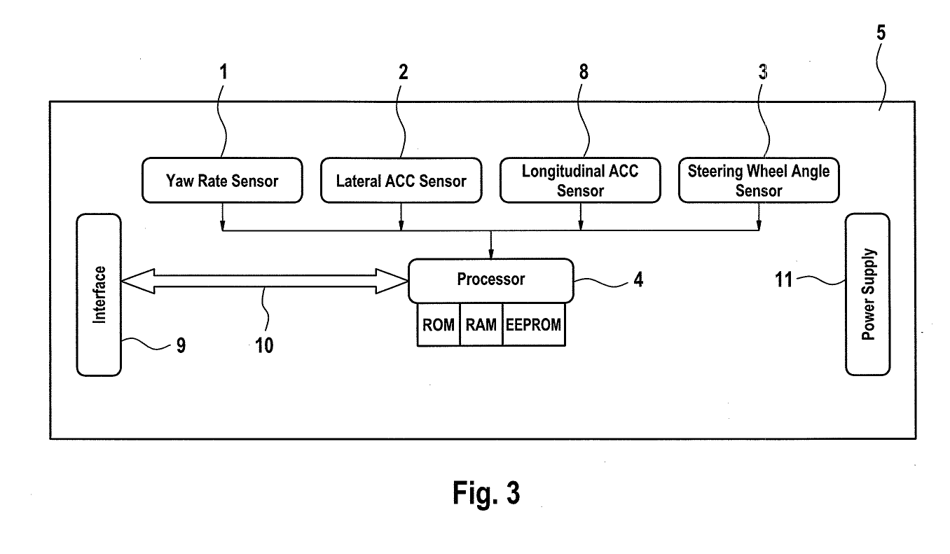

The major elements of an exemplary embodiment of the vehicle sensor device according to the invention are shown in FIG. 3. The driving dynamics variables yaw rate, longitudinal acceleration, lateral acceleration and steering angle are measured with installed sensors, wherein the yaw rate sensor 1, lateral acceleration sensor 2, longitudinal acceleration sensor 8 and steering wheel angle sensor 3 have a signaling connection to the computing unit 4. Necessary evaluation electronics may also likewise be on circuit board 5. Preferably, the combination of the sensors, e.g. whether a longitudinal acceleration sensor is installed, is changed depending on the requirements of the respective vehicle. If, as in the embodiment explained using FIG. 2, the computing unit is additionally used for control of an electrical steering system, then relative values of the steering angle can be measured in the electrical steering system, so that no separate or additional steering angle sensor has to be installed in the vehicle sensor device. Depending on the desired availability, it can also especially be provided that one or more sensors are configured as redundant, enabling a comparison of the sensor data in addition to a plausibility check using the data of other sensors. Said variant is particularly advantageous if the computing unit of the vehicle sensor device is also implemented as a redundant core microcontroller and thus satisfies increased reliability requirements. The communications between the intelligent sensor cluster and other vehicle systems or control devices are implemented by means of an interface 9, which is connected for example to a data bus 10 according to known Standards (CAN, FlexRay). The intelligent sensor cluster comprises a power supply 11, which is connected to the vehicle electrical system (e.g. K1_{—}30) of the vehicle and provides suitable (especially stabilized) voltages for the sensors, computing unit and interface.

The processing of the measured values takes place in a computing unit or a processor. Particularly advantageous is the use of a microcontroller that already comprises a non-volatile memory such as a ROM, in which the programs or software modules are stored. The functions provided are preferably changed depending on the requirements, wherein—as described below—a plurality of software modules can be selected. Vehicle and software parameters are preferably written into an EEPROM of the microcontroller. Vehicle parameters for the application of the device to a type of vehicle can for example be determined in driving tests.

According to another exemplary embodiment the computing unit of the intelligent sensor cluster can also provide driving dynamics control. In particular, if a plurality of electromechanical wheel brakes is being used, each comprising a dedicated control device, a central brake system control device can therefore be omitted. Alternatively or additionally, the vehicle sensor device is preferably used as an airbag control device at the same time.

One advantage of the intelligent sensor cluster is that inexpensive relative sensors can be used for the steering angle measurement. A relative steering angle sensor always indicates a value of zero for the steering angle following its initialization (when starting the ignition), irrespective of whether the steering is actually in the central position at this point in time. The respective current steering angle is measured relative to the first value, therefore all steering angles measured during a journey have a constant displacement. Said displacement must be determined very quickly (during the first seconds of travel) and taken into account in the vehicle systems. A single track model of the vehicle is preferably used as the basis for calculating the steering angle displacement. The yaw rate, lateral acceleration and vehicle speed and also the vehicle parameters (mass, axle separation, steering ratio and others) are necessary for the calculation. Said variables are available in the intelligent sensor cluster. Theoretical values of the steering angle are calculated based on the model. The theoretical values are only then used for the calculation if the model is valid. The time sequences, i.e. series of successive values for the measured and theoretical steering angle, are advantageously processed using statistical methods. The driving conditions and the statistical properties of the time sequence are taken into account for this. For checking the validity of the model, the time derivative of the yaw rate is preferably monitored. If the derivative is too large, the model results are not used for the calculation. In addition, other known conditions can be used for checking the validity of the model.

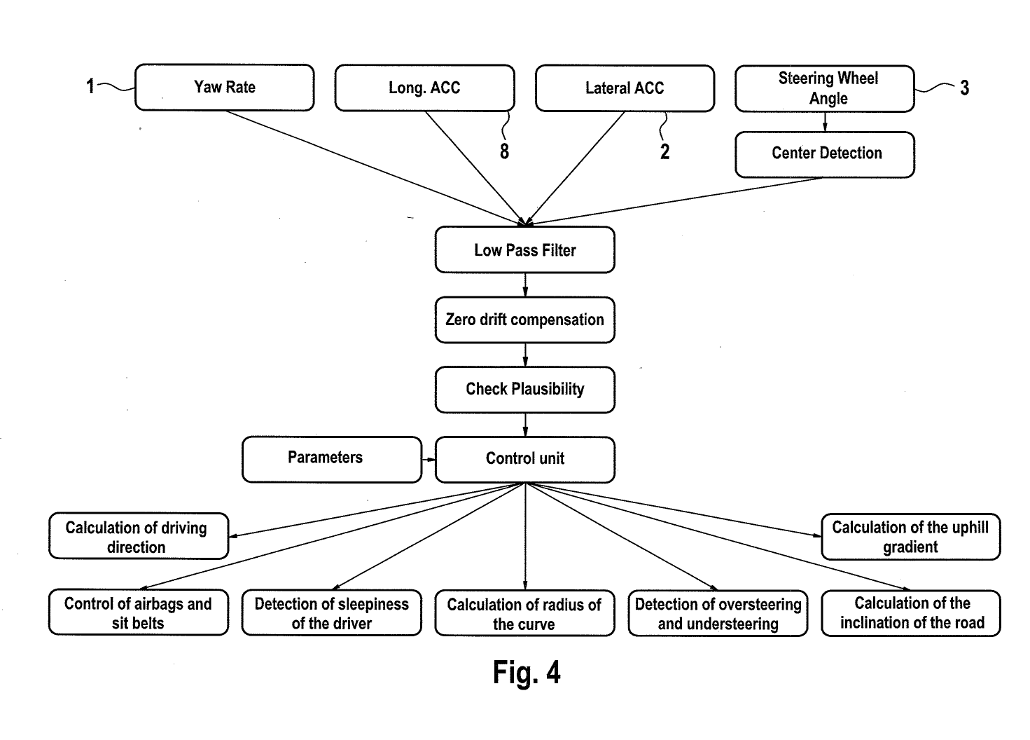

FIG. 4 shows an exemplary schema of the software architecture. The signals of the yaw rate sensor 1, lateral acceleration sensor 2, steering wheel angle sensor 3 and preferably longitudinal acceleration sensor 8 are delivered to the computing unit. Any offset errors of the steering angle signals, i.e. displacements of the null angle relative to the steering wheel position for straight line travel, are corrected in a “Center Detection” module. This is especially important for relative steering angle sensors, but absolute sensors can in principle also have an offset, e.g. owing to mechanical tolerances. The sensor signals or sensor data are subsequently subjected to low pass filtering by a “Low Pass Filter” module in order to suppress short-term fluctuations. Slow drift of the sensor signals is detected and corrected in a “Zero drift compensation” module. Here it can e.g. be checked whether the yaw rate of a stationary vehicle is given as null (as should be the case). A plausibility check of the sensor data then takes place in a “Check Plausibility” module. Here other information received via a data bus can also possibly be used. The sensor data are subsequently delivered to a “Control unit” control module, which controls the other software modules taking into account received parameters or “Parameters” that are placed in a dedicated memory area. The different modules can include a driving direction detection “Calculation of driving direction” module, the control of airbags and/or belt tensioners “Control of airbags and seat belts” module, a driver fatigue warning “Detection of Sleepiness of the Driver” module, a calculation of the current turn radius “Calculation of radius of the curve” module, detection of understeer or oversteer “Detection of oversteering and understeering” module, a calculation of lateral highway inclination or vehicle tilt “Calculation of the inclination of the road” module or determination of the gradient on a hill “Calculation of the uphill gradient” module.

One advantage of the intelligent sensor cluster is that a plurality of additional calculations and control functions can be integrated in the software of the vehicle sensor device. The software advantageously has a modular architecture. Said modular architecture has the advantage that the different software modules can be activated depending on the requirements of the current vehicle. Here the above-mentioned modules and almost any additional functions can be integrated to form a vehicle dynamics control means.

According to a preferred embodiment of the invention, an electronic control device, which especially controls a brake system, requests one or more functions in the vehicle sensor device according to the invention when starting a journey, i.e. when starting the ignition. This preferably checks whether the desired functions can be provided by using the provided sensors and the result of an initialization or of a self-test. Consequently, a message regarding the available functions is output via the corresponding interface to the electronic control device and the corresponding functionality is provided for the duration of the journey.

According to an alternative preferred embodiment of the invention the functions to be provided are stored in an application field in the EEPROM of the vehicle sensor device. The functions are preferably implemented or activated in the vehicle sensor device depending on the requirements. The activation of the function module can particularly preferably be implemented in a control module, wherein the configuration of the control module can be changed for example by means of a corresponding change of one or more parameters.

Very particularly preferably, the activation or deactivation of each software module is carried out depending on the parameter values. Thus all devices can be supplied with one software version and only the necessary functions are activated during initialization.

The initial null displacement of the steering angle is advantageously calculated in a software module for the steering angle null point detection (“Center Detection”). It represents another advantage of the intelligent sensor cluster that the compensation of the null displacements of the sensor because of any drift can be carried out internally in the device. For example, it can be taken into account that with the vehicle stationary the yaw rate must be zero. A stationary state of the vehicle can be detected using the acceleration sensor or sensors or received vehicle speed data. The yaw rate measured in the stationary state can thus be used as a measure of a null displacement of the sensor. A null position of the steering angle sensor is advantageously determined in the first seconds after ignition, wherein the corresponding calculations can be subsequently repeated many times, whereupon an average value is preferably determined for the results. A difference between the determined average value and the null position of the steering angle sensor can be taken into account as a null drift of the steering angle sensor. Moreover, the average values of the yaw rate, accelerations and steering angle over long time intervals can be calculated. Preferably, the results are used to update the null displacements.

According to the invention the plausibility checking of the measured values is carried out internally in the device, for which purpose the yaw rate, the acceleration(s) and especially the steering angle are preferably used. For example, values of the steering angle calculated by means of the single track model can be compared with measured values. If the differences are too great, the measurement values are advantageously classified as implausible. Such a comparison preferably only takes place in favorable driving conditions, wherein these are particularly preferably defined in the software module for steering wheel center determination.

It can also be checked whether the ratios between the yaw rate Ψ, lateral acceleration a_{Lat} and vehicle speed V are plausible:

|a_{Lat}−ψ*V|<ε₄

ε₄—threshold value

Said threshold value is advantageously selected in view of possible highway inclinations.

Depending on the embodiment, one or more of the following software modules can be implemented in the sensor device:

One module is advantageously responsible for monitoring and controlling the airbags and the belt tensioners, wherein for example the vehicle acceleration can be used as an input variable. If the vehicle acceleration suddenly assumes very large negative values, the airbags are preferably activated and the belts are tensioned:

$$\sqrt{{a}_{Lat}^{2} + {a}_{long}^{2}} > A$$

$$\vert \frac{\partial ( \sqrt{{a}_{Lat}^{2} + {a}_{Long}^{2}} )}{\partial t} \vert > B$$

$${a}_{Lat} < 0$$

$${a}_{Long} < 0$$

A, B—threshold values.

a_{Lat}—lateral acceleration

a_{Long}—longitudinal acceleration

The high reliability of the power supply necessary for the use as an airbag control device, especially with a capacitor which also provides the energy for ignition of the airbags in the event of failure of the vehicle electrical system, is also available for the intelligent vehicle sensor. Acceleration sensors normally used for triggering of an airbag have a measurement range containing higher accelerations and are thus preferably also used for detecting faults that cause errors in the signals of the driving dynamics acceleration sensor.

The highway gradient for a steep highway can be calculated in another module according to the yaw rate, lateral acceleration and vehicle speed:

$$β = Arc cos ( \frac{{a}_{Lat} - ψ * V}{g} )$$

β—highway gradient

g—acceleration due to gravity

One module can be used for measurement of the highway gradient with the vehicle stationary. This is particularly important for the systems for a starting aid such as e.g. a hill-start aid and can be calculated advantageously as follows:

$$γ = Arc cos \frac{{a}_{Long}}{g}$$

γ—highway gradient

The highway gradient can also be estimated while travelling. For this purpose for example the time derivative of vehicle speed can be calculated with:

$$γ = Arc cos \frac{( {a}_{Long} - \frac{\partial V}{\partial t} )}{g}$$

A module for the detection of the direction of travel can for example compare the time derivative of the vehicle speed and the longitudinal acceleration with each other. If the signs for the two values are identical the “forwards” direction of travel is advantageously detected. If the signs are different the “rearwards” direction of travel is advantageously detected:

$$sign ( {a}_{Long} ) = sign ( \frac{\partial V}{\partial t} ) \overline{} forwards$$

$$sign ( {a}_{Long} ) = - sign ( \frac{\partial V}{\partial t} ) \overline{} rearwards$$

In the stationary case

$$( {a}_{Long} \approx \frac{\partial V}{\partial t} \approx 0 )$$

for example the signs for the lateral acceleration and the yaw rate can be compared with each other:

$$sign ( {a}_{Long} ) = sign ( ψ ) \overline{} forwards$$

$$sign ( {a}_{Long} ) = - sign ( ψ ) \overline{} rearwards$$

In another module a calculation of the turn radii is preferably carried out:

$$R = \frac{V}{ψ}$$

R—turn radius

Turn radii can for example be used for adaptive control of the headlamps.

The state of fatigue of the driver is preferably detected in a software module, wherein for example the time derivatives of the steering angle can be monitored, which can be used as a basis for detecting driver fatigue. If the driver is tired, the steering wheel is not moved for a long time interval and then a sudden movement is carried out. In this case a warning signal can be output. By said detection of the specific steering movement, driving safety is thus increased by rousing the driver from a microsleep.

1.-15. (canceled)

16. A vehicle sensor device, comprising at least one sensor for detecting the yaw rate of a vehicle, at least one sensor for detecting the lateral acceleration of a vehicle, at least one computing unit and at least one interface of a data bus via which the sensor signals or sensor data derived therefrom can be transmitted to at least one electronic control device, wherein a steering angle sensor is only connected to the vehicle sensor device and is especially integrated with the other sensors in a housing, and the computing unit carries out at least one of plausibility checking, calibration of the yaw rate signals, lateral acceleration signals, and steering angle signals.

17. The vehicle sensor device as claimed in claim 16, wherein vehicle speed data are received via at least one interface, and the yaw rate signals and lateral acceleration signals are plausibility checked using said data, by checking whether the product of yaw rate and vehicle speed deviates in magnitude by not more than a specified threshold value from the measured lateral acceleration.

18. The vehicle sensor device as claimed in claim 17, wherein the vehicle speed data contains a vehicle speed derived from at least one of wheel revolution rate sensors, wheel speeds of a plurality of wheels, and a vehicle speed derived from navigation data.

19. The vehicle sensor device as claimed in claim 16, wherein a calibration of relative steering angle signals takes place at least using the data or signals of the yaw rate sensor and/or of the lateral acceleration sensor, and absolute steering angle data are provided via at least one data bus interface.

20. The vehicle sensor device as claimed in claim 16, wherein the computing unit is implemented as a redundant core microcontroller.

21. The vehicle sensor device as claimed in claim 20, wherein at least one sensor of a yaw rate sensor, a lateral acceleration sensor and a steering angle sensor are implemented in redundant form.

22. The vehicle sensor device as claimed in claim 16, further comprising at least one longitudinal acceleration sensor.

23. The vehicle sensor device as claimed in claim 16, further comprising a module for controlling airbags, wherein the data of one or more acceleration and/or structural sound sensors is evaluated by the computing unit.

24. The vehicle sensor device as claimed in claim 16, wherein the computing unit controls a servomotor for assisting the steering movement by the driver, and applies an additional steering torque according to data received via the at least one interface.

25. The vehicle sensor device as claimed in claim 16, further comprising a power supply device, which is connected to a vehicle electrical system of the vehicle and provides at least one stabilized voltage, and comprises a capacitor that can bridge a failure of the vehicle electrical system for at least a specified period of time.

26. The vehicle sensor device as claimed in claim 16, wherein the computing unit carries out checking for driver fatigue, wherein a warning is output if the steering wheel angle and/or the steering wheel angular rate fall(s) below a first specified threshold value for a first specified period of time and subsequently exceed(s) a second specified threshold value before the expiry of a second specified period of time.

27. The vehicle sensor device as claimed in claim 16, wherein the computing unit provides functions for one or more control devices according to a request by an electronic control device and/or according to a check of the provided sensors and/or according to a stored configuration, wherein transmission of data is carried out via at least one interface.

28. A use of a vehicle sensor device as claimed in claim 16, in a brake system for a motor vehicle driven by an internal combustion engine and/or at least one electric motor, wherein the brake system comprises means for the driver-independent build-up of brake torque at one or more wheels and at least one electronic control device, which receives signals from at least one wheel revolution rate sensor and controls the means for the driver-independent build-up of brake torque, and wherein the vehicle sensor device and the electronic control device are connected to each other via at least one data bus.

29. The use as claimed in claim 28, wherein the computing unit of the vehicle sensor device carries out vehicle dynamics control and sends brake demands to the control device(s) of the brake system via at least one interface of a data bus, wherein especially the wheel brakes of at least one axle are electromechanically operated.

30. The use as claimed in claim 28, wherein the brake system at the wheels of at least one axle comprises hydraulic wheel brakes and a hydraulic block with at least one pump and at least one hydraulic valve, and that the electronic control device can control the hydraulic block for driver-independent changing of the brake pressure.

31. The vehicle sensor device as claimed in claim 16, wherein the data bus is a CAN bus or a FlexRay bus.
